(19) United States
(12) Patent Application Publication
(10) Pub. No.: US 2020/0387912 A1
(43) Pub. Date: Dec. 10, 2020

(54) CUSTOMIZED ORDER FULFILLMENT

(71) Applicant: HEWLETT-PACKARD DEVELOPMENT COMPANY, L.P., Spring, TX (US)

(72) Inventors: Will Allen, Corvallis, OR (US); Greg Blythe, Corvallis, OR (US); Barbara Pickering, Palo Alto, CA (US); Tyler Sims, Corvallis, OR (US); Steven J Simske, Fort Collins, CO (US); Robert Ulichney, Stow, MA (US); Carlos Haas, Palo Alto, CA (US)

(21) Appl. No.: 16/607,132

(22) PCT Filed: Oct. 18, 2017
(86) PCT No.: PCT/US2017/057170

§ 371 Date: Oct. 22, 2019

(51) Int. Cl. G06Q 30/00; G06Q 30/06; G06Q 10/10; G06Q 30/02; G06F 16/23; H04L 29/06; G06K 9/00

(52) U.S. Cl. CPC G06Q 30/0185; G06Q 30/0621; G06Q 30/0643; G06Q 30/0635; G06K 9/00288; G06Q 30/0282; G06F 16/2379; H04L 63/0861; G06Q 10/10

(57) ABSTRACT

In one example, a computer system for customized order fulfillment includes modules in a computer readable medium that a processor executes. An order module accepts an order for an object from a customer with a set of options, a set of preferences, and a representation of the customer. A unique ID module associates a unique ID with the object. A binding module physically binds the unique ID as an appurtenance of the object. A display module displays the representation of the customer in a vicinity of the of the appurtenance for the object after fulfillment of the order.

### BACKGROUND

Electronic commerce systems, such as Internet-based shopping systems, allow purchasers to purchase products remotely electronically and in some cases later visiting an actual store for pickup. At the same time, those stores may have local customers that are also placing orders. Accordingly, large quantities of orders may be placed by customers remotely via access devices and locally within the store. Delivery of the orders to the appropriate customer has been less than an ideal experience for the customers due to the confusion of the products arrival at common fulfillment locations at the stores.

### BRIEF DESCRIPTION OF THE DRAWINGS

The disclosure is better understood regarding the following drawings. The elements of the drawings are not necessarily to scale relative to each other. Rather, the emphasis has instead been placed upon illustrating the claimed subject matter. Furthermore, like reference numerals designate corresponding similar parts through the several views. For brevity, reference numbers used in later drawings that are repeated may not be re-described.

FIG. 1 is an illustration showing an example environment for customized order fulfillment;

FIG. 2 is a block diagram of a system used for customized order fulfillment;

FIG. 3 is an example set of database tables;

FIG. 4A is an example label with a set of example barcodes for an angle-independent unique ID;

FIG. 4B is an example container including the label of FIG. 4A.

FIG. 4C is another example container including an angle-independent Link Technology™ unique ID and a customer representation viewing area;

FIG. 5A is an example of another angle-independent unique ID;

FIG. 5B is another example of the angle-independent unique ID;

FIG. 6A-6D are illustrations of various customized order delivery examples;

FIG. 7 is an example server system for implementing customized order fulfillment;

FIG. 8 is an example module to accept feedback from customers after their order has been delivered;

FIG. 9 is an example computer readable medium with instructions to implement customized order fulfillment;

FIG. 10 is an example set of additional instructions; and

FIG. 11 is a flowchart of an example process for customized order fulfillment.

### DETAILED DESCRIPTION

Disclosed is a system and method for improving customized order delivery that improves a customer's experience and improves the efficiency of the fulfillment process. The system allows for continued interaction with a customer after order fulfillment and thereby permits for improving future order fulfillment events by detecting variances perceived by the customer and/or capturing positive customer experiences during the fulfillment. A set of preferences for the customer based on the perceived variances and positive experiences may be updated. The proposed customized order fulfillment technique also allows for brand protection from counterfeit products and reducing errors made in the fulfillment of specialized orders for the customer. A further benefit is that confusion may be significantly reduced or eliminated when customers retrieve their custom orders from a common fulfillment area. More detail and examples follow in the description below.

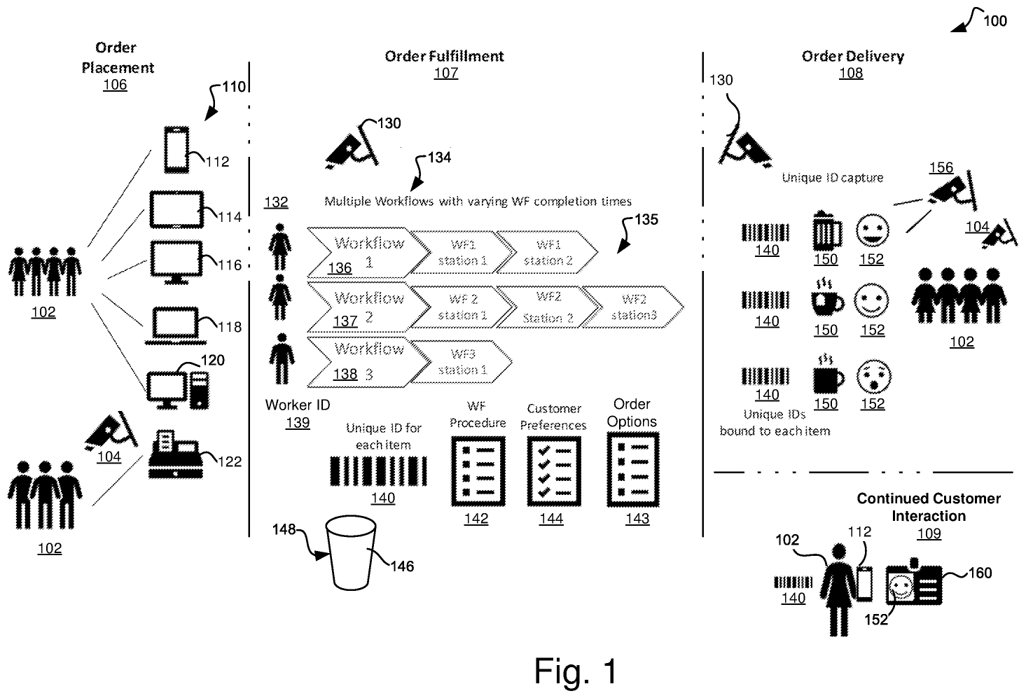

FIG. 1 is an illustration of one order fulfillment environment 100, such as at a coffee bar. While this discussion for the sake of clarity and conciseness is directed to a customize order fulfillment in a coffee bar, a fictitious “Bookshelf Coffee” shop (no representation or identification to any actual coffee shop or another entity present, past, or future is intended or should be inferred), the disclosed system and process is applicable to other areas where a) a customized workflow is followed; b) there is a potential for many objects to be created or grouped based on lots of various options; and c) there is a potential for confusion when delivering the finished objects to the appropriate customer. Further, the described system and process improves efficiency and reduces errors particularly when the time needed to fulfill a customized order varies depending on the particular one of several possible workflow processes needed to fulfill it. Such situations exist in the food and beverage industry in general, customized electronics setup such as cell phone delivery or personal computer configurations, online shopping order fulfillment, pharmacy orders, community based medical screening or vaccination clinics, as just some examples. In this environment 100, there are three main progressions that take place. The first is order placement 106, the second is order fulfillment 107, and the third is order delivery 108. The technique may also include a fourth progression of continued customer interaction 109.

In the first progression, order placement 106, multiple customers 102 may place orders in several various ways. For instance, they may place orders using multiple ordering devices 110, including a smartphone 112 (which may also entail cellphones, personal data assistants, e-readers, phablets, and the like), a tablet 114, a monitor 116 (such as an order kiosk, table-based electronic menu, light clients, and the like), portable computer 118 (such as laptops, notebooks, netbooks, and the like), and personal computers 120 (such as desktops, servers, gaming consoles, TV streaming devices, and the like). More conventional ordering to an intermediate party such as a waitperson, a counter representative, a drive-up window, etc. and entered into an ordering system 122 may also occur.

In all ordering situations, there may be a camera 104 in the electronic devices or separately to take a picture of the customer or perform facial recognition of the customer or both. Facial recognition of the customer may be just to identify a customer from another group of customers and not necessarily recognize the customer by name. Further, other biometric inputs such as fingerprints, voice recognition, retinal scans, and the like may also be used to identify the customer from other customers. In some examples, facial recognition attributes used in facial recognition may not be kept as a permanent record and only generated at a time of order. The customer can also be identified by scanning a previous order, or by use of various ID tokens such as key fobs, customer loyalty cards, RFID tags, cell phone ID, and the like. The multiple customers 102 may each place individual custom orders by selecting from a set of options to create order options 143 and selecting from a set of preferences known about the respective customer 102. The set of preferences may be an empty set in some situations. A representation 152 of the customer 102 may also be entered, such as a picture taken by camera 104, a stored image of the customer 102, another stored image, a color, emoji, icon, or another marking. In some examples, a check is made to the ordering system to ensure that the representation 152 of the customer 102 is sufficiently unique from other customers 102 that have already placed orders that have not been fulfilled. If the customer 102 has placed a prior order that has not been fulfilled and then places an additional order, a separate image or icon may be used, or the chosen image or icon may be modified to add additional information to allow it to be distinguished from the earlier order customer representation 152.

In the second progression, order fulfillment 107, the orders from customers 102 are received for an object 150, and each order includes the chosen set of order options 143 and preferences and the customer representation 152. After receipt of order, a unique ID 140 is created, assigned or otherwise associated with the order for each item in a multiple workflow fulfillment process 134 that has a separate workflow 136, 137, 138 with one or more workflow stations 135 to be performed by multiple workers 132. Each workflow station 135 may have a unique workflow ID for identification of the point in the workflow process. Each workflow 136, 137, 138 may be completed with varying workflow completion times and may have a different number of workflow steps 135 that occur at one or more workflow stations 135. The workflow at each workflow station 135 may be performed by one or more of the multiple workers 132. Each of the multiple workers 132 may have a unique worker ID 139 assigned to them to allow for tracking and monitoring of the performance of each worker 132.

The unique ID 140 may be created in several different ways. In one example, the unique ID may be requested from a global product authentication service on the Internet or locally on a local network. One such authentication service is Hewlett-Packard Enterprise™ Global Product Authentication Service (HPE-GPAS™) that allows for the generation of unique security codes. For instance, HPE-GPAS™ provides a mass serialization engine that offers cryptographic security for generating unique product security codes. These secure codes are GS1 GTIN-compliant and may be used to identify an appurtenance 148. Appurtenance 148 may be a container 146, a wrapper such as a sleeve for container 146, an appendage such as a straw or stirring stick, a component of the order such as the object or its case, an attachment such as a label, or an addition such as a printed or otherwise formed mark. While the container 146 in this example is shown as a cup, the container 146 may be a shipping box, a storage box, a pill container, a bag, etc. In this situational environment, the appurtenance 148 is subordinate to the more important order but is adjunct to it and may or may not be an integral part of the order. With respect to the HPE-GPAS™, batches of unique IDs 140 may be requested and delivered to suppliers for pre-printing prior to customer orders. In other situations, the unique ID 140 may be fully or partially created by printing onto container 148 or labels at the time of ordering. The HPE-GPAS™ service may also provide for brand protection. Other serialization services to provide unique ID 140 include HP™ Inc.'s Indigo™ Smart Stream™ software and HP™ Link Technology™.

For instance, in an online ordering fulfillment environment, container 146 may be a shipping box. Rather than using a label printed with unique ID 140, the containers 146 may be preprinted with the unique ID 140 so that each shipping box received is individually serialized and the unique ID 140 cannot be removed from it, by accident, by intent, or otherwise. The pre-printed shipping boxes can be checked on arrival and non-authenticated (based on invalid unique IDs 140) counterfeit boxes diverted out of the workflow. In some examples, the unique ID 140 is printed on the shipping boxes in an angle-independent manner and is readable however the shipping box is oriented. This can be performed by printing on all faces of the shipping box so even if one copy is marred or unreadable; the unique ID 140 is readable on that face elsewhere. Multiple marks may be used for the unique ID 140 to provide a tiered security of information. In some examples, the multiple marks may include a hash, digital signature, or another mark, solely or in addition to the use of the unique ID 140 as a unique serialization. The unique ID 140 may also be created from multiple marks.

For example, the unique ID 140 may be created from an existing serial number or barcode with an additional mark to improve the uniqueness and allow for future interaction with the customer 142 to occur. For instance, a serialization of the unique ID may be distributed across multiple marks to expand the serialization to permit a one order-to-one person mapping such that each order is ensured of a unique ID 140, over time and large populations, that has not been previously used. This technique allows the use of existing marks to be used and the unique ID 140 would only come together after the multiple marks are successfully read. For instance, one barcode mark may contain 38-bits of serialization (such as SGTIN-96). Another barcode mark may be included along with the first to increase the serialization by another 32 bits thereby increasing the serialization to 70 bits total. 2\hat{ }⁷⁰ is more than 1 Sextillion (1×10\hat{ }²¹) unique IDs 140. A Sextillion would allow 1 Billion customers to have 1 Trillion (10\hat{ }¹²) unique orders. The implementation of a particular unique ID 140 should allow for an extremely low probability of repeating. For instance, QR codes that are widely used and commercially available may encode about 470 raw bits of information. Allowing for a 3:1 ratio of raw bits to info bits with error detection and correction included, the QR code can represent about 2\hat{ }¹⁵⁶ unique patterns or almost 1 Quindecillion (10\hat{ }⁴⁸) unique patterns. This is almost as much as the entire number of 10\hat{ }⁵⁰ molecules that make up the planet earth. However, QR codes are widely used and to ensure uniqueness, they may be combined with an additional code to provide more serialization, tiered security, and ensure complete uniqueness from other uses of the QR codes.

QR codes and other barcodes may not be visually pleasing nor always available for reading as they are often placed on the back of containers to hide their appearance. HP Inc.™ Link Technology™ linkcreationstudio.com may be used to provide each container 146 or appurtenance 148 a unique ID 140 that is integrated (digitally watermarked) into the color of the images of the package labeling rather than or in addition to barcode labels and that is readable by a LinkReader™ mobile app. In some examples, the unique ID 140 is designed and implemented to be angle-independent to allow for reading of the unique ID 140 with minimal or no worker 132 interaction. In some examples, a wrap-around unique ID 140 is used. In one example, Link Technology™ can be used to encode the unique ID 140 into a logo that is repeated around a container 146. In other examples, the unique ID may be removable after fulfillment to allow for proper display of brands or other information.

After a unique ID 140 is associated with the order, it is physically bound as an appurtenance of the order, such as by printing on a container, a sleeve, a box, a wrapper as just a couple of examples. The unique ID 140 follows the order through the appropriate workflow 136, 17, 138 for the order to fulfill the object 150. If the unique ID 140 is pre-printed or otherwise marked ahead of the order, the unique ID 140 may be scanned or read by a unique ID 140 capture device 130 during the association with the order. Each of the workflows 136, 137, 138 may have a workflow procedure 142 for the workers 132 to follow. At appropriate steps in the multiple workflows 134, the appropriate workflow procedure 142 may be displayed at each workflow station 135 in the workflow 134 along with the order options 143 and any relevant customer preferences 144. In some examples, the customer preferences 144 may be converted to variances in the workflow procedures 142 or order options 143. For instance, if the customer preference is for “less milk,” the workflow procedure 142 may state rather than ‘less milk,’ ‘place 1 oz. of milk in drink’ in place of the standard ‘place 2 oz. of milk in the drink.’ The unique ID 140 capture device 130 may be located at the different workflow stations 135 to allow for workflow tracking and to display the appropriate workflow procedure 142 and customer preferences 144. After the order is completed, the environment 100 then proceeds to the third progression, order deliver 108

In the third progression, order delivery 108, the order is delivered to the appropriate customer. However, due to the varying time of each order through the multiple workflows 134, the possibility of similar orders, the number of waiting customers 102, and limited space to perform the delivery, the customer experience may be less than wished for by the customer 102.

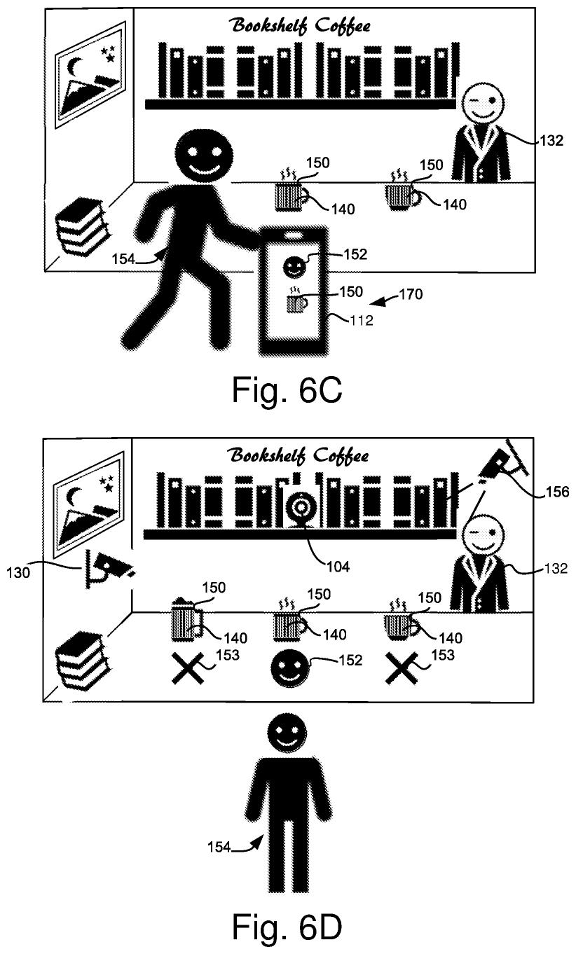

An improvement of the customer experience is accomplished by having the unique ID 140 scanned with a capture device 130 on each finished object 150 and displaying the customer representation 152 in a vicinity of the finished object 150 at the time of fulfillment. The display may be performed using a customer representation display device 156, such as a display or projector. Additional improvement can be accomplished by having a facial recognition camera 104 to read and identify each of the waiting customers and comparing a customer ID from the facial recognition with the customer ID associated with the unique ID 140. Since the number of waiting customers 102 at the order fulfillment may be relatively small (less than 20) and the number of possible multiple waiting customers 102 only somewhat larger (less than 100), the facial recognition can be simplified and sped up compared to the facial recognition used at the time of order placement 106 where the number of potential multiple customers 102 is quite large. Various options for presenting the customer representation 152 along with the finished object 150 are discussed below in FIGS. 6A-6D.

In some examples, the environment 100 may continue to a fourth progression, continued customer interaction 109. After the finished object 150 has been delivered, the unique ID 140 on an appurtenance 148 may be kept by the customer 102. The unique ID 140 may be scanned by a customer device such as smartphone 112 (or any of the multiple ordering devices 110). The scanning may initiate a call to a website for the vendor of the order, verification that the finished object is not counterfeit, or it may pull up a survey 160 for the customer 102 to complete about their experience. The survey or a website may pull up the customer representation 152 for the respective customer, so they know they are accessing their previous order information. Various feedback may be taken and analyzed and based on the analysis, the customer preferences 144 may be updated as well as the workflow procedures 142 based on a sufficient sample of multiple customers 102.

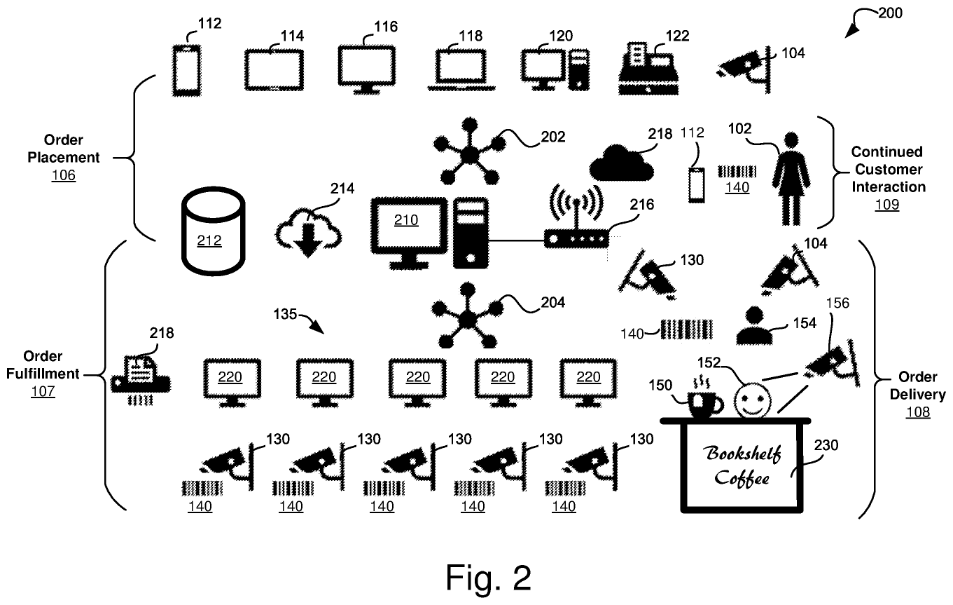

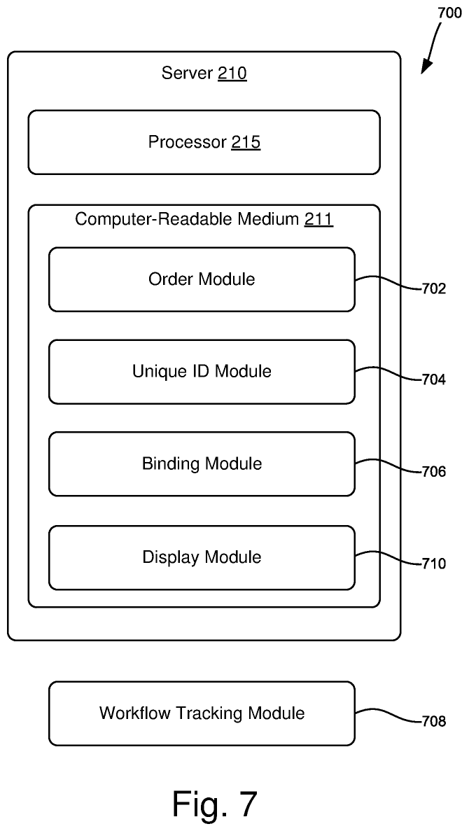

FIG. 2 is a block diagram of an example system 200 to implement the customized order fulfillment environment 100 of FIG. 1. For order placement 106 the system 200 may include a first network 202 that communicates with multiple input devices 110, such as smartphone 112, tablet 114, monitor 116, portable computer 118, desktop computer 120, and ordering system 122. The first network 202 may be a private or public network and may be based on one or more known network protocols. The first network 202 may also be coupled to a camera 104 for facial capture and/or facial recognition of customers 102. The first network 202 also communicates with a server 210 that contains instructions in computer readable medium 211 (FIG. 7) that when read and executed by one or more processors 215 (FIG. 7) in server 210, the order placement 106, the order fulfillment 107, the order deliver 108 and the continued customer interaction 109 progressions are implemented. First network 202 may be a secure local network, such as a virtual private network (VPN) or it may be connected to the internet to allow customer 102 to connect without having to log onto a separate virtual private network. In some examples, first network 202 may be a local wireless hotspot without connection to the internet.

The server 210 may be connected to one or more databases 212 via a secure connection 214, either another network, an encrypted session on a second network 204 such as a virtual private network, a direct connection, or another communication link. The database 212 may be a cloud-based database located at one or more remote sites, and secure connection 214 may be implemented as a secure link partially or completely over the Internet. In other examples, the database 212 may be locally present in server 210, and secure connection 214 may be a SATA, SCSI, or other storage communication interface. The database 212 may be a relational SQL based database (such as MySQL™, MariaDB™, PostgreSQL™, Microsoft™ SQL™ server, Oracle™, etc.), a non-relational flat database (such as Vertica™, MongoDB™, CouchDB™, Hazelcast™, Redis™, Memcached™, Cassandra™, Hbase™, etc.), or newSQL transaction database (such as Google™ F1/Spanner™, Citus™, ScaleBase™, MemSQL™, NuoDB™, VoltDB™, etc.).

To implement the order fulfillment 107 progression, server 210 is connected to a second network 204 that is secure and typically kept separate from first network 202 which is exposed to third parties. In some examples, first network 202 and second network 204 may be the same hardware network but implemented in different software sessions. For instance, first network 202 may be an open network and second network 204 may be a closed VPN network but share the same physical infrastructure.

Server 210 is connected via the second network 204 to one or more printers 218 to produce secure IDs 140 in some examples. The secure IDs 140 may be placed on labels that are attached to an appurtenance 148 of the order, or the secure IDs 140 may be printed directly on the appurtenance 148 of the order, such as container 146. Server 210 may also be connected to one or more clients 220, typically at each workflow station 139, but some stations may not require a client 220. Clients 220 may be displays, monitors, thin-clients, standalone PCs and laptops running remote session software, and the like. The clients 220 may also include data entry devices, such as mice, keyboards, touchscreens, keypads, pen input, etc. The clients 220 display the appropriate workflow procedures 142 and customer preferences 144 when an order is at the respective workflow station 135. Each workflow station 135 may include a unique ID capture device 130 to capture the unique ID 140 of the order when it arrives at the respective workflow station 135. The client 220 and/or unique ID capture device 130 may also be used to read and a record worker ID 139. Based on the worker ID 139, the worker 132 may or may not have access to the workflow procedure 142 and customer preferences 144. Thus, the workflow stations 135 may have role-based access for the workers 132. This may help prevent a worker 132 who has not been trained properly from performing the respective workflow procedure 142 thereby preventing potential harm to the worker 132 or customer 102. Also, during fulfillment of the object 150, the server 210 may send information at the point in the workflow to an app of the customer 158 to allow the customer 158 to track the workflow of the object 150 that was ordered.

For order delivery 108, the server 210 is connected via network 204 to a secure ID capture device 130 to read the secure ID 140 that is associated with each finished object 150. In some examples, the secure ID 140 can be read independent of the angle and thus placement of the finished 150 requires little time and effort by the worker 132 at the fulfillment station 230. In some examples, server 210 may also be connected to a camera 104 to recognize waiting customers 102 to identify them facially. After secure ID 140 has been captured, the appropriate order information is used by server 210 to call up the respective customer representation 152 for the order from database 212 and display using the display device 156 the customer representation 152 in the vicinity of the respective finished object 150. The waiting customers 102 can easily identify if any objects at the fulfillment station 230 are their order or not based on the displayed customer representation 152, which may be a picture of them or a chosen picture or icon they chose at the time of ordering.

For continued customer interactions 109, the server 210 may be coupled to a third network 216, typically the Internet 218 or another cloud-based network, to allow remote access by a customer 102. The customer 102 may scan secure ID 140 with an app on smartphone 112. The app may access system 200 and allow the user 102 to fill out a survey about the fulfillment experience and whether the user's expectations were met or not. Alternatively, or in addition to the survey, the app may also allow the customer 102 to be directed an appropriate website for more information about the order or future orders.

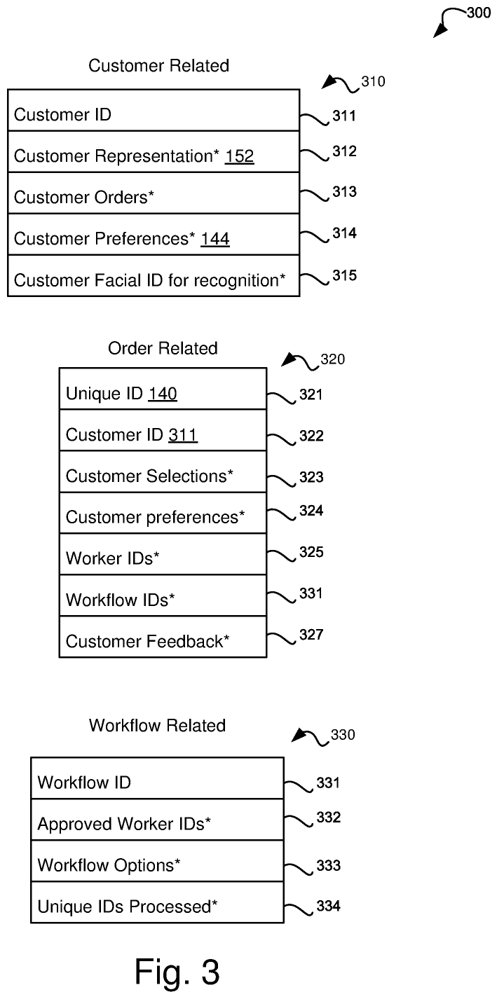

FIG. 3 is a set of example database tables 300 for use with the example database 218 to help fulfill the order. Only some of the possible tables and fields will be discussed, and many other tables and fields are possible and likely. Other table organizations and linking are possible. An asterisk (*) at the end of a field name indicates the field contains a pointer to another table or list for the items indicated by the field name.

In customer related table 310, there is a Customer ID field 311 used to assign a number or other identification to the customer 102. In one example, a unique ID 140 may be assigned as a customer ID in field 311 to ensure each customer can be individually identified within the database. In another example, an existing or newly created member loyalty ID may be used to represent the customer ID in field 311. The customer related table 310 may also include a customer representation* field 312 to point to an image, drawing, icon, emoji, or other graphical item used to identify the customer 102 visually. In some examples, there may be multiple images from different angles to help in facial recognition. In many examples, customer representation will be a picture(s) of the customer 102 taken at the time of the order or an icon selected by the customer 102 at the time of order. A customer order* field 313 is used to point to a table that includes all the unique IDs 140 that the customer has used in various past and current orders. Customer preferences* field 314 is used to point to a table that includes a list of various customer preferences that a customer 102 may have. These preferences may be dependent on what order options 143 are selected for the order. Thus, for each option, there may be a different set of customer preferences. Customer preferences may also be organized based on the worker ID 139 or even the time of day. A customer facial ID for recognition* field 315 may point to a table that includes various characteristics of the customer 102 face that are determined by a facial recognition program based on an analysis of the customer representation 152 stored in the location pointed to by the customer representation field 312. There may be multiple sets of characteristics representing each image of the customer 102 that is pointed to by customer representation* field 312.

Order related table 320 may be used to manage each order. Every order has a unique ID field 321 storing a unique ID 140 to ensure that each order is unique in the database and can be recalled later. For each order, a customer ID field 322 stores the customer ID 311 from the customer 102 that placed the order. A customer selections* field 323 points to a list that includes each of the various order options 143 selected by the customer for the particular order. Customer preferences* field 324 points to a list of the particular customer preferences selected by a customer 102 at the time of order or from a list of customer preferences determined from feedback from prior orders by the customer 102. A worker IDs* field points to a list of the various workers who worked at workflow various stations 135 in the fulfillment of the order. Having this information is useful in determining if certain workers are producing high or low-quality objects. For instance, if customer feedback is frequently negative for orders that a particular worker participated in, then a corrective action such as additional training, reassignment, or other may be taken. If feedback is frequently positive for orders that a particular worker participated in, and more so than other workers, then that worker may be rewarded, promoted, or used to train other workers. Accordingly, a customer feedback* field 327 is used to point to a list of customer feedback received for the order. Each order may be analyzed to determine if customer expectations have been met or not. The customer feedback may be analyzed to look for variances from what the customer expected. The variances found may be used to update the customer preferences pointed to by the customer preferences* field 324 to improve the next product experience by the customer.

A workflow related table 330 may be used to track operations performed at various workflow stations 135 in the multiple workflows 134. A workflow ID field 331 may be used to identify each of the various workflow stations 135. An approved worker IDs* field 332 may be used to point to a list of worker IDs that represent which the multiple workers 132 may be qualified or otherwise based on their role be able to perform the various workflow station 135 procedures. For instance, for a coffee bar, a worker 132 who has not been trained on safety, preventative maintenance, and failure response for an espresso machine that operates steam at high temperature and pressure may not be allowed to operate the espresso machine as that worker 132 may not have his/her respective worker ID 135 in the list of approved worker IDs. A workflow options* field 333 may be used to point to a list of various procedures for a worker 139 to follow at a respective workflow station 135 for the workflow ID in workflow ID field 331. A unique IDs processed* field 334 may be used to keep a list of the various orders based on their unique IDs 140 that have been processed at that workflow station 135.

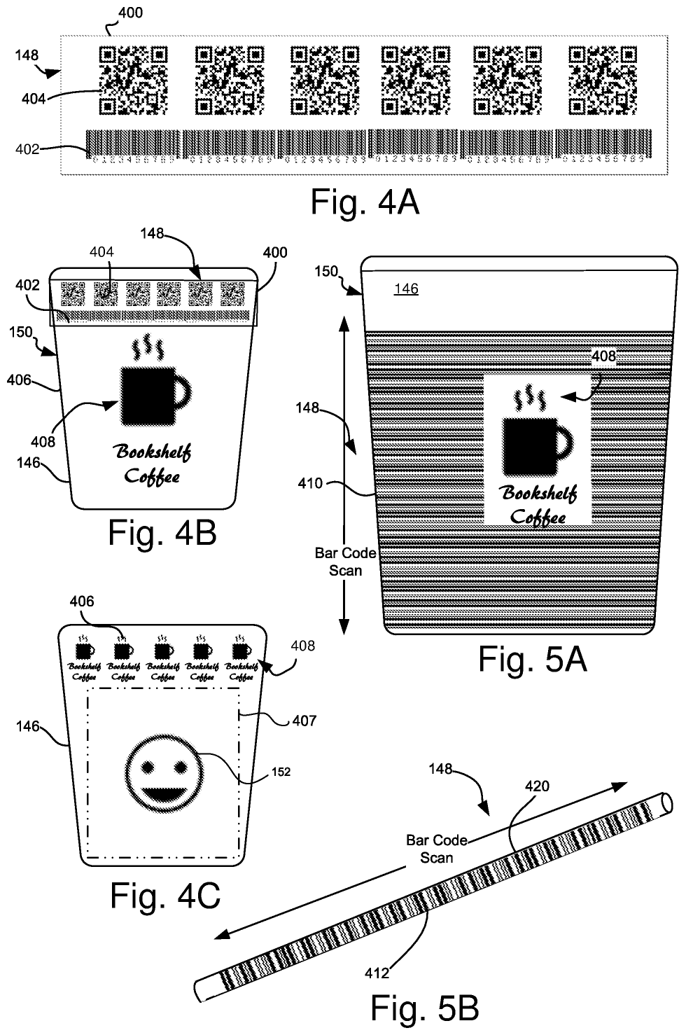

FIG. 4A is an example appurtenance 148, a label 400, with a set of example barcodes for an angle-independent unique ID 140. In this example, a set of six identical QR codes 404 are printed in a repeating pattern. As noted, a QR code 404 can represent about 2\hat{ }¹⁵⁶ unique patterns or almost 1 Quindecillion (10\hat{ }⁴⁸) unique patterns. However, QR codes 404 are commercially available and used in many applications. To ensure uniqueness or provide for the tiered security of information, a different set of additional barcodes 402 (each identical but having different information from QR codes 404) can be added to the label 400 to increase the number of bits of information both to differentiate uniqueness and add any additional features such as additional tiered security, error correction, vendor IDs, etc. The label 400 may be designed to be placed onto a container 146 so that the label may be scanned from any angle around the container 146 and thus be angle independent. Although the appurtenance 148 in FIG. 4A is shown as a label 400, the QR code 404 and additional bar code 402 may be printed on the container 146 or an appurtenance 148 sleeve that fits over the container 146. In other examples, the QR code 404 and additional bar code 402 may be printed directly on the container 146.

FIG. 4B is an example container 146 including the label 400 of FIG. 4A applied to it. Typically, for ease of scanning or reading the barcodes, they may be placed near the top of the container 146 to allow for placement of a logo 408. The label 400 may be designed to be removable from the container 146 of finished object 150 to allow a customer 142 to keep the label for later use. In other embodiments, the label 400 may be replaced with a removable sleeve that has the barcodes printed thereon like the organization of the label 400.

FIG. 4C is another example container 146 including an angle-independent Link Technology™ unique ID 406 and a customer representation viewing area 407. The logo 408 embeds the unique ID 406 using Link Technology™ to encode the unique ID 406 using digital watermarking such as by subtle but non-human readable alterations of the logo 408. The logo 408 is replicated multiple times around the container 146 to allow it to be read from multiple angles, thus making it angle independent. The remaining portion of the container 146 may be left blank to allow for a customer representation 152 to be projected onto the customer representation viewing area 407. In some examples, the customer representation 146 may be chosen to be a unique color, marking, emoji, or other non-image representation.

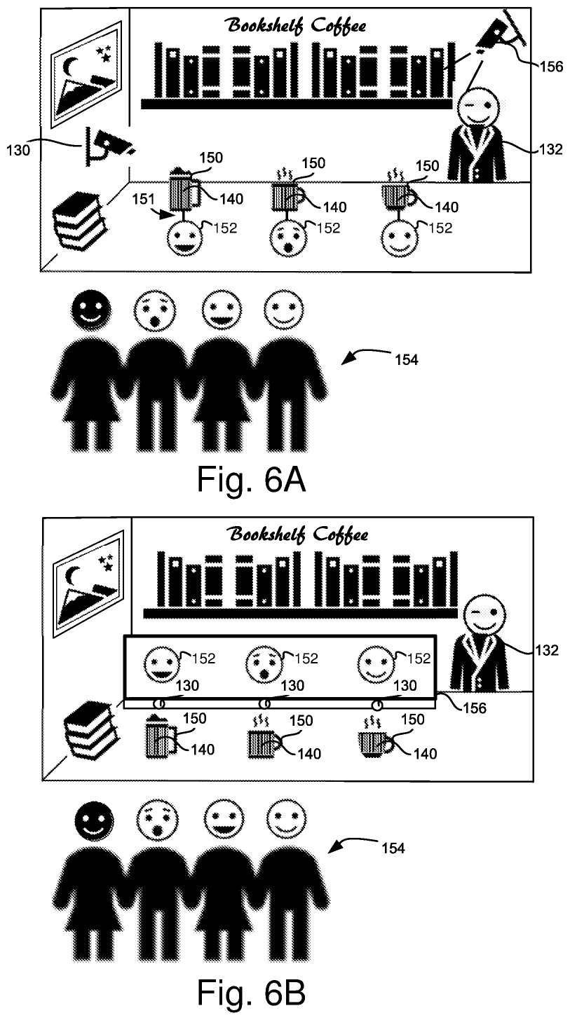

FIG. 5A is an example of another angle-independent unique ID 140 on a container 146 appurtenance 148 or alternatively as a sleeve that fits over the container 146 with a wrap-around 1D barcode 410. In this example, the wrap-around 1D barcode 410 is a layer of varying thickness bars that encircle the container 146. In other examples, the unique ID 140 may be encoded into an image as a digital watermark using Link Technology™. The bar code 410 can be scanned vertically from any direction around the container 146 thereby making it angle-independent. The logo 408 may be placed within the barcode 410 as shown but to improve the presentation of the finished object 150, the logo may be printed or otherwise applied to a sleeve that slips over the container 146 to hide the barcode 410. In the examples where the bar code 410 is applied to a sleeve and used during the workflow, the sleeve may be removed and replaced with another sleeve to improve presentation but the sleeve with the bar code 410 provided as well to the customer 402 as appurtenance 148 to allow the customer to scan for continued customer interaction 109.

FIG. 5B is yet another example of the angle-independent unique ID 150 as a straw or stirring stick 420 appurtenances 148. In this example, a wrap-around 1D bar-code 412 is applied (printed, etched, burned, etc.) onto the appurtenance 148 to allow the customer 402 to more easily keep the appurtenance 148 after consuming a finished object 150. In some examples, the straw or stirring stick 420 may be attached to a sleeve or the container 146 during order fulfillment, so it is not easily separated from the container 146 during the workflow process. In other examples, a first angle-independent bar-code is used as a sleeve or applied to the container 146 and used during the workflow process. A second bar-code (possibly non-angle independent), of the same or different type as the first bar-code, is applied to a straw or stirring stick but encodes the same information as that on the first bar-code to allow a customer 102 to remove and keep the second bar-code for continued customer interaction 109. In addition to straws or stirring sticks 420, the second barcode could be applied to napkins, business cards, as stickers on loyalty cards, tokens, and the like. By having the first barcode and the second barcode both encode the same information, the unique ID 140, the customer 102 may scan the code for future interaction. While angle independence helps to ensure an efficient and mistake-free fulfillment of the order during the workflow up to and including the order delivery 108, angle independence of the code used to encode the unique ID 140 after order fulfillment is not always required depending on the type of appurtenance 148 used.

FIG. 6A-6D are illustrations of various customized order delivery 109 examples. In FIG. 6A, a group of waiting customers 102 are gazing at the delivery area of the coffee bar, and there are multiple finished objects 150 available. While shown in this illustration as having different containers, in some situations the containers could be the same or the finished object 150 could be of the same order options 143. To prevent confusion, speed up the delivery, and increase the customer experience, a capture device 130 may be used to read the unique IDs 140 on each finished object 150. A display device 156, such as a projector, may be used to display or project the respective customer representations 152 onto a surface in the vicinity of the corresponding finished object 150. In some examples, a line 151 connecting the customer representations 152 to the finished object 150 may also be displayed to eliminate confusion further. When the unique IDs 140 are angle independent, the worker 132 just places the finished object 150 on the surface and the waiting customers 102 can quickly ascertain which of the finished object 150 is thereby visual id of their displayed customer representation 152. In some examples, the display device 156 may project an improved surface image, such as a wood grain countertop, a granite countertop, a faux tile countertop, and the like along with the customer representation 152 images. In other examples, rather than displaying the customer representation 152 images near the finished object 150, the image may be projected directly on the container 146 of finished object 150.

FIG. 6B is another example of order delivery 108 similar to that of FIG. 6A. However, in this situation, rather than using a projector to display customer representations 152, a flat panel display device 156 is used to display the customer representations 152. The display may have multiple capture devices 130 positioned across the front of the display. While three capture devices 130 are shown in this example, there may be more or less. In this situation, the worker 132 need only place a finished object 150 in front of the one of the capture device 130. The capture device 130 then reads and decodes the unique ID 140 of the finished object 150 and the system 200 displays the corresponding customer representation 152 from the database for that unique ID 140 on the display device 156. Once the finished object 150 is removed from the area on the surface by the respective waiting customer 102, the customer representation 152 is removed from the display device 156 and the worker 132 may place another finished object 150 in the empty location.

FIG. 6C is another example of order delivery 108 that includes an augmented reality (AR) app 170 that runs on a waiting customer's 102 smartphone 112 (or another ordering device 110) to privately see the personalized delivery information. In this example, the worker 132 simply places finished objects 150 on the surface, and the waiting customer 102 uses his smartphone 112 to open the AR app 170. The AR app 170 can use the smartphone 112 camera to view and display the surface of the delivery area including the finished objects 150. The AR app software can use the image taken from the camera to read and decode the unique ID 140 on the finished objects 150. If a unique ID 140 matches the unique ID assigned during ordering, the AR app may display the customer representation 152 as if it were floating above the corresponding finished object 150 on the display of the smartphone 170. Other personalized delivery information other than the customer representation 152 may include information about the order such as what was ordered, any customer preferences used in the order, caution statements such as for heat, or time since the order was completed and waiting at the delivery station 230. By only scanning for the unique ID 140 of the smartphone owner's order, security is maintained in that the waiting customer 102 cannot see customer representations 152 of the other finished objects 150 waiting at the counter.

FIG. 6D is another example of order delivery 108 that includes facial recognition with a camera 104 and provides security so that only those waiting customers 102 with the proper authentication can view respective customer representations 152 and no others. In this example, the capture device 130 reads and identifies the unique IDs 140. The camera 104 may be set up to scan the facial images of the waiting customers 102 using facial recognition. As the waiting customer 102 approaches the delivery station 230, the customer's face is scanned, compared against stored customer facial ID 315 for recognition data (See FIG. 3). If recognized, then the customer ID 311 is used to pull the respective customer representation 152 (which could be a customer image, illumination highlighting, color, emoji, or another marking) for display on the surface or container 146 of the corresponding finished object 150. Any finished objects 150 that are not part of the order of the waiting customer 102 and are also at delivery station 230 may be marked with an “X” or another indicator to indicate that it is not for the waiting customer 102. In this example, the waiting customer 102 can determine which finished object 150 is his or hers without knowing to whom which of the remaining finished objects 150 belong. The security-based examples in FIGS. 6C and 6D may be important in sensitive areas such as alcohol delivery, prescription delivery, betting tickets delivery, and the like.

The various examples described herein may include logic or several components, modules, or constituents. Modules may constitute either software modules, such as code embedded in the tangible non-transitory machine or computer readable medium 211 or hardware modules. A hardware module is a tangible unit capable of performing certain operations and by be configured or arranged in certain manners. In one example, one or more computer systems or one or more hardware modules of a computer system may be configured by software (e.g., an application, or portion of an application) as a hardware module that operates to perform certain operations as described herein.

In some examples, a hardware module may be implemented as electronically programmable. For instance, a hardware module may include dedicated circuitry or logic that is permanently configured (e.g., as a special-purpose processor 215, state machine, a field programmable gate array (FPGA) or an application specific integrated circuit (ASIC) to perform certain operations. A hardware module may also include programmable logic or circuitry (e.g., as encompassed within a general-purpose processor 215 or another programmable processor) that is temporarily configured by software to perform certain operations. It will be appreciated that the decision to implement a hardware module electronically in dedicated and permanently configured circuitry, or in temporarily configured circuitry (e.g., configured by software) may be driven by cost and time considerations.

For instance, FIG. 7 is an example of a computer system, server 210 of FIG. 2, for implementing customized order fulfillment for an object 150. The object 150 may be one of many objects 150 from different customers 102 processed during the workflow 132 that proceeds through the workflow 132 at different speeds and resulting in different completion times. The server 210 includes one or more processors 215 having one or more cores to execute modules of instructions. The server 210 may be a single mechanical packaged desktop server, a rack-based server, a part of a server farm, a multitude of servers in a server warehouse, a cloud-based server, or one or more virtual servers. The server 210 includes a non-transitory computer-readable medium 211 that includes instructions organized in modules.

The computer-readable medium 211 allows for storage of one or more sets of data structures and instructions (e.g., software, firmware, logic) as modules embodying or utilized by any one or more of the methodologies or functions described herein. The instructions may also reside, completely or at least partially, with the static memory, the main memory, and/or within the processor 215 during execution by the computing system. The main memory and the processor memory also constitute computer-readable medium 211. The term “computer-readable medium” 211 may include single medium or multiple media (centralized or distributed) that store the one or more instructions or data structures. The computer-readable medium 211 may be implemented to include, but not limited to, solid-state, optical, and magnetic media whether volatile or non-volatile. Such examples include, semiconductor memory devices (e.g. Erasable Programmable Read-Only Memory (EPROM), Electrically Erasable Programmable Read-only Memory (EEPROM), and flash memory devices), magnetic discs such as internal hard drives and removable disks, magneto-optical disks, and CD-ROM (Compact Disc Read-Only Memory) and DVD (Digital Versatile Disc) disks.

During order placement 106, an order module 702 includes instructions to accept an order for an object 150 from a customer 102 with a set of order options 143, a set of preferences 144, and a representation 152 of the customer. As discussed previously for the order placement 106 progression, the order may be placed using one or more of the multiple ordering devices 110. During ordering, a camera 104 may be used to take the customer representation 152 such as a customer image and the server 210 may perform facial recognition on the taken image. There may be multiple customers 102 each inputting a respective order for an object to be delivered by a set of multiple workflows 134. An analysis of the image taken may be stored in a list of facial characteristics pointed to by the customer facial ID for recognition field 315 in a customer related database table 310. Based on the facial recognition, customer entry, or another identification step, the customer 102 is given a customer ID 311 used to index the customer related table 310. The customer related table 310 may also include a pointer to the customer representation 152, a pointer to the customer order for the object, including any order options 143 selected, and a pointer to any known customer preferences 144.

During order fulfillment 107, a unique ID module 704 has instructions to associate a unique ID 140 with the object 150. The instructions may include code to create the unique ID by requesting from a cloud-based service such as HPE's GPAS service, or code to create the unique ID using two or more markings such as 1D barcodes, 2D QR codes, and other machine-readable markings. The unique ID used should be chosen to eliminate the probability that any two objects using the server 210 would have the same unique ID 140. As noted, the unique ID 140 can be made of multiple markings to allow for tiered security, error checking, error correction, and the addition of additional data. Therefore, the unique ID 140 may be distributed across multiple marks where the unique ID 140 only comes together after the multiple marks are successfully read. In some examples, the unique ID 140 may be replicated over multiple marks when bound in binding module 706.

A binding module 706 includes instructions to physically bind the unique ID 140 as an appurtenance 148, such as container 146 of the object 150. The binding module 706 may include instructions to print the unique ID 140 on the appurtenance 148 for the object 150 encoded into an angle-independent machine-readable set of markings. In some examples, the binding module 706 may include instructions to encode the unique ID 140 into at least two separate sets of markings. The binding module 706 may also include including an initiation module with instructions to read a first set of markings from a container 146 preprinted before ordering, and to print a second set of markings on the container 146. Accordingly, the unique ID 140 may be distributed across the preprinted first and printed second set of markings. This binding may include one or printing, labeling, stamping, etching, burning, or otherwise physically marking an encoded unique ID 140 onto the appurtenance 148. The appurtenance 148 may be a container 146, sleeve, box, wrapper, straw, stirring stick, utensil, condiment, or another item that is related to the object 150 during order fulfillment.

In some examples, a workflow tracking module 708 may include instructions to read the unique ID 140 and a workflow ID at each workflow station 135 at a point in the workflow 136-138 to display on monitors 220 a workflow procedure 142 with the set of order options 143 and the customer preferences 144 based on the unique ID 140 and the workflow ID 331. In other examples, an existing workflow may be used and the customer preferences noted on the appurtenance 148, such as a container 146.

During order delivery 108, a display module 710 includes instructions to display the representation 152 of the customer 102 in a vicinity of the of the appurtenance 148 for the object 150 after fulfillment of the order. Various techniques for performing the order delivery were discussed previously in relation to FIGS. 6A-6D. At delivery station 230 a capture device 130 may be used to read the encoded unique ID 140 on the appurtenance 148 of the finished object 150. Based on the decode unique ID 140, the database may be queried to retrieve information about the order, including the customer representation 152. To help identify the proper finished order 150 for a particular customer 102 among a group of multiple waiting customers 102, a display device 156, such as a projector or display, may be used to the display of the representation 152 of the waiting customer 102 by one of projection adjacent to the appurtenance 148, projection onto the appurtenance 148, displayed adjacent to the appurtenance 148, and displayed floating above the appurtenance 148 using augmented reality. In some examples, the display module 710 code may include a facial recognition module using a camera 104 to scan and identify the waiting customer 102 at the time of fulfillment and to generate a warning when the waiting customer 102 is not the customer 102 that created the order for the finished object 150.

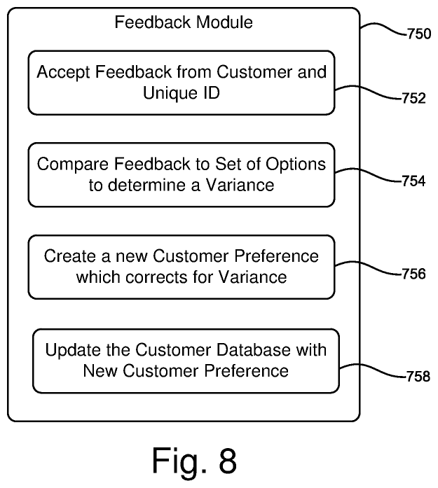

FIG. 8 is an example feedback module 750 to accept feedback from customers 102 after their order has been fulfilled. At continued customer interaction 109, the computer readable medium 211 may include a first module 752 with instructions to accept feedback from the customer 102 along with the unique ID 140. A second module 754 has instructions to compare the feedback with the set of order options 143 entered for the order to determine a variance. For instance, a survey may be accessed by the customer 102 scanning the secure ID 140 with an app on their smartphone. Based on the survey results, in third module 756, the code can create a new customer preference 144 which corrects for the variance. Fourth module 758 may contain code to update the customer database, such as customer-related table 302, with new customer preferences 144. Additional modules may be including a communication module to send information at the point in the workflow to an app of the customer 158 to allow the customer 158 to track the workflow of the object 150 that was ordered.

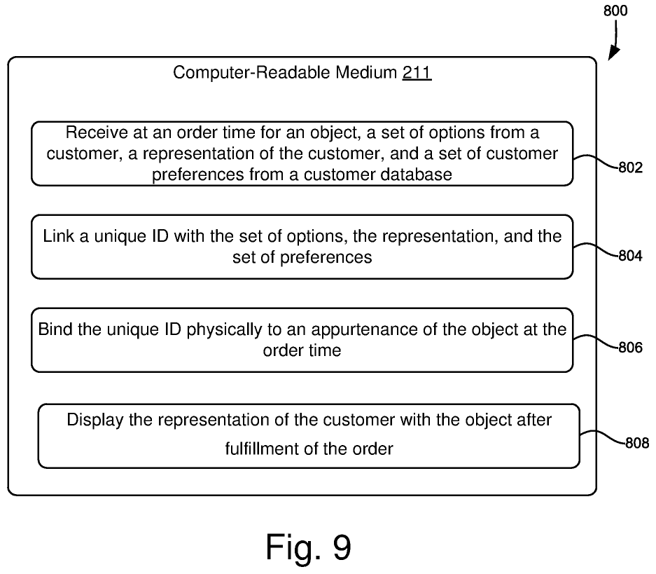

FIG. 9 is block diagram 800 of an example computer readable medium 211 with instructions for customized order fulfillment. In block 802 the instructions allow a processor 210 to receive at an order time for an object 150, a set of order options 143 from a customer 102, a representation 152 of the customer 102, and a set of customer preferences 114 from a customer database 310. In block 804 the instructions allow the processor 215 to link a unique ID 140 with the set of order options 143, the representation 152, and the set of preferences 114. In block 806, the processor 215 may bind the unique ID 140 physically to an appurtenance 148 of the object 150 at the order time. In block 808, the processor 215 may display the representation 152 of the customer with the object 150 after fulfillment of the order.

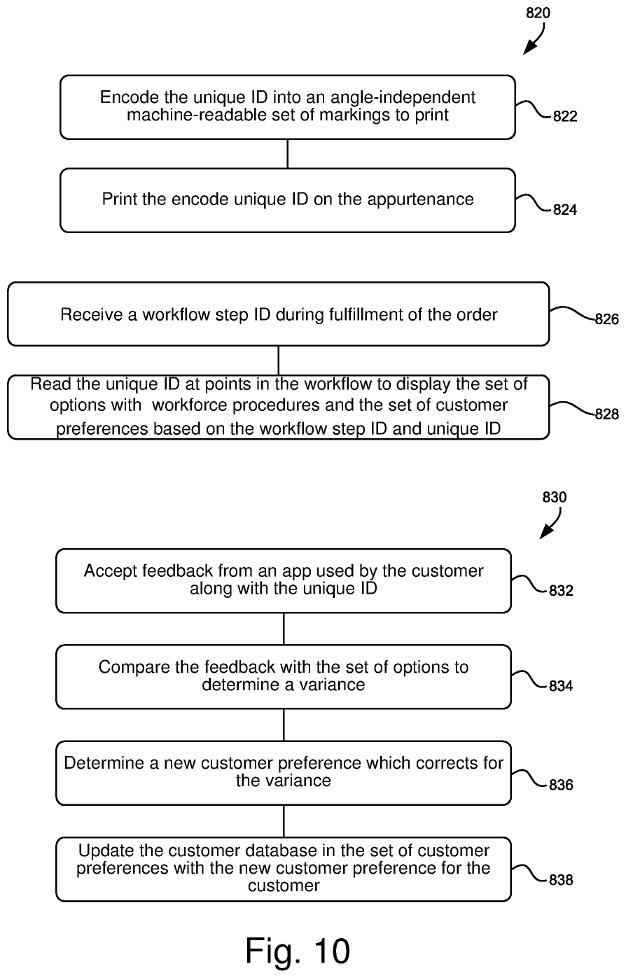

FIG. 10 is an example set of additional instructions 820 and 830 that may be stored on computer-readable medium 211. For additional instructions 820, in block 822 the processor 215 may encode the unique ID 140 into an angle-independent machine-readable set of markings to print and in block 824 print the encode unique ID 140 on the appurtenance 148. In block 826, the processor 215 may receive a workflow step ID 331 during fulfillment of the order 150. In block 828, the processor may read the unique ID 140 at points in the workflow 134 to display the set of order options 143 with workflow procedures 142 and the set of customer preferences 144 based on the workflow ID 331 and unique ID 140.

In additional instructions 830, block 832 may allow the processor 215 to accept feedback from an app used by the waiting customer 158 along with the unique ID 140. In block 834, the processor 215 may compare the feedback with the set of order options 143 to determine a variance and in block 836 determine a new customer preference 144 which corrects for the variance. In block 838, the processor 215 may update the customer database 310 in the set of customer preferences 314 with the new customer preference 144 for the customer 158. Other instructions may allow the processor 215 to display the representation 152 of the customer by one of projection adjacent to the appurtenance 148, projection onto the appurtenance 148, displayed adjacent to the appurtenance 148, and floating above the appurtenance 148 using augmented reality.

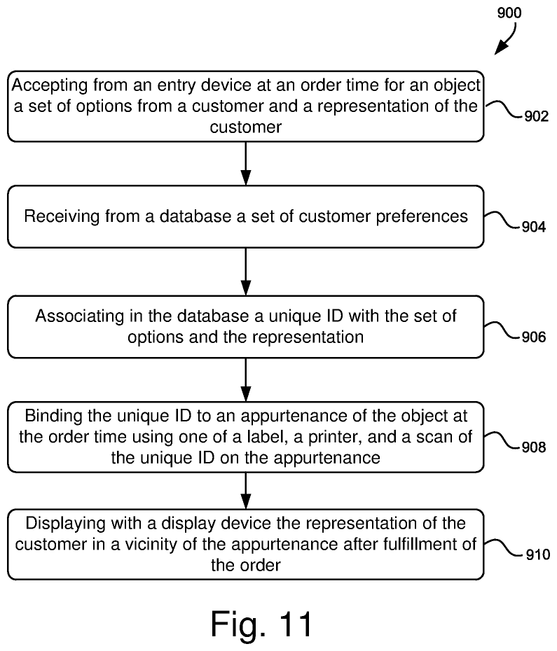

FIG. 11 is a flowchart of an example process 900 for customized order fulfillment for a computer-implemented method performed by a processor 215 (FIG. 7) executing instructions for customized order fulfillment from a non-transitory computer-readable medium 211 (FIG. 7). The instructions may include in block 902, accepting from an entry device 110 at an order time for an object 150 a set of order options 143 from a customer 102 and a representation 152 of the customer 102. In block 904, the instructions allow for the processor 215 receiving from a database 212 a set of customer preferences 144. In block 906, the instructions allow for the processor 215 associating in the database 212 a unique ID 140 with the set of order options 143 and the representation 152. In block 908, the instructions allow for the processor 215 binding the unique ID 140 to an appurtenance 148 of the object 150 at the order time using one of a label, a printer, and a scan of the unique ID 140 on the appurtenance 148. In some examples, the instructions allow for the processor 215 tracking in the database 212 with a workflow ID the object through a workflow 134 to fulfill the order. The instructions may also allow for the processor 215 displaying on a set of clients 220 at each workflow location 135 the set of order options 143 and the set of customer preferences 144 based on the workflow ID 331. In block 910, the instructions allow for the processor 215 displaying with a display device 156 the representation 152 of the customer in a vicinity of the appurtenance 148 after fulfillment of the order.

Other instructions may allow for the processor 215 accepting feedback from an app used by the customer along with the unique ID and comparing the feedback with the set of order options 143 to determine a variance. The instructions may also allow for the processor 215 determining a new customer preference which corrects for the variance, and updating the database with the new customer preference for the customer in the set of preferences.

While the claimed subject matter has been particularly shown and described with reference to the foregoing examples, those skilled in the art will understand that many variations may be made therein without departing from the intended scope of subject matter in the following claims. This description should be understood to include all novel and non-obvious combinations of elements described herein, and claims may be presented in this or a later application to any novel and non-obvious combination of these elements. The foregoing examples are illustrative, and no single feature or element is to be used in all possible combinations that may be claimed in this or a later application. Where the claims recite “a” or “a first” element of the equivalent thereof, such claims should be understood to include incorporation of one or more such elements, neither requiring nor excluding two or more such elements.

What is claimed is:

1. A computer system for customized order fulfillment, comprising:
a non-transitory computer-readable medium including instructions organized in modules;
a processor to execute the modules, the modules including:
an order module to accept an order for an object from a customer with a set of options, a set of preferences, and a representation of the customer;
a unique ID module to associate a unique ID with the object;
a binding module to physically bind the unique ID as an appurtenance of the object; and
a display module to display the representation of the customer in a vicinity of the of the appurtenance for the object after fulfillment of the order.

2. The system of claim 1, further comprising a workflow tracking module to read the unique ID and a workflow ID at a point in a workflow to display a workflow procedure with the set of options and the customer preferences based on the unique ID and workflow ID, wherein the object is one of many objects from different customers processed during the workflow that proceeds through the workflow at different speeds.

3. The system of claim 2 further comprising a communication module to send information at the point in the workflow to an app of the customer to allow the customer to track the workflow of the object.

4. The system of claim 1, wherein the binding module includes instructions to print the unique ID on the appurtenance for the object encoded into an angle-independent machine-readable set of markings.

5. The system of claim 4, wherein the binding module includes instructions to encode the unique ID into at least two separate sets of markings.

6. The system of claim 5, further including an initiation module with instructions to read a first set of markings from the appurtenance preprinted before ordering, and to print a second set of markings on the appurtenance, wherein the unique ID is distributed across the first and second set of markings.

7. The system of claim 1 wherein the display of the representation of the customer is one of projection adjacent to the appurtenance, projection onto the appurtenance, displayed adjacent to the appurtenance, and displayed floating above the appurtenance using augmented reality.

8. The system of claim 1 further comprising a facial recognition module to scan and identify the customer at the time of fulfillment and to generate a warning when the customer is not the customer that created the order.

9. The system of claim 1 further comprising:
a feedback module to:
accept feedback from the customer along with the unique ID,
compare the feedback with the set of options to determine a variance,
create a new customer preference which corrects for the variance, and
update the customer database with the new customer preference in the set of preferences.

10. A non-transitory computer-readable medium, including instructions for customized order fulfillment that when read and executed by a processor cause the processor to:
receive at an order time for an object, a set of options from a customer, a representation of the customer, and a set of customer preferences from a customer database;
link a unique ID with the set of options, the representation, and the set of preferences;
bind the unique ID physically to an appurtenance of the object at the order time;
display the representation of the customer with the object after fulfillment of the order.

11. The computer-readable medium of claim 10 further comprising instructions to:
encode the unique ID into an angle-independent machine-readable set of markings to print; and
print the encode unique ID on the appurtenance;
receive a workflow step ID during fulfillment of the order; and
read the unique ID at points in the workflow to display the set of options with workflow procedures and the set of customer preferences based on the workflow step ID and unique ID.

12. The computer-readable medium of claim 10 further comprising instructions to:
accept feedback from an app used by the customer along with the unique ID;
compare the feedback with the set of options to determine a variance;
determine a new customer preference which corrects for the variance; and
update the customer database in the set of customer preferences with the new customer preference for the customer.

13. The computer-readable medium of claim 10 further comprising instructions to display the representation of the customer by one of projection adjacent to the appurtenance, projection onto the appurtenance, displayed adjacent to the appurtenance, and floating above the appurtenance using augmented reality.

14. A computer-implemented method performed by a processor executing instructions for customized order fulfillment from a non-transitory computer-readable medium, the instructions comprising:
accepting from an entry device at an order time for an object a set of options from a customer and a representation of the customer;
receiving from a database a set of customer preferences;
associating in the database a unique ID with the set of options and the representation;
binding the unique ID to an appurtenance of the object at the order time using one of a label, a printer, and a scan of the unique ID on the appurtenance; and
displaying with a display device the representation of the customer in a vicinity of the appurtenance after fulfillment of the order.

15. The method of claim 14 further comprising:
accepting feedback from an app used by the customer along with the unique ID;
comparing the feedback with the set of options to determine a variance;
determining a new customer preference which corrects for the variance; and
updating the database with the new customer preference for the customer in the set of preferences.
